(19) United States
(12) Patent Application Publication
(10) Pub. No.: US 2007/0150924 A1
(43) Pub. Date: Jun. 28, 2007

(54) Image display control apparatus, image display system, image display control method, computer program product, sub-display control apparatus for image display system, and image display method

(75) Inventors: Shuhei Ichinose, Tokyo (JP); Mitsuyoshi Amano, Tokyo (JP); Kumi Nakayama, Tokyo (JP); Shigeki Yatabe, Tokyo (JP); Shinichi Shirasaka, Tokyo (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); PIONEER SOLUTIONS CORPORATION, Tokyo (JP)

(21) Appl. No.: 11/634,387

(22) Filed: Dec. 6, 2006

(30) Foreign Application Priority Data
Dec. 6, 2005 (JP) 2005-352030
Dec. 6, 2005 (JP) 2005-352098

(51) Int. Cl. H04N 7/18

(52) U.S. Cl. 725/78

(57) ABSTRACT

In an image display system, the control device (110) of a host computer (100) performs an image displacement process in accordance with a program stored in a USB memory (120). By the image displacement process, a pointer (300), which is an image, is displaced between the main display (140) of the host computer (100) and the sub display (220) of a display apparatus (200). Moreover, the sub display (220) is authenticated on the basis of authentication information (122) stored in the USB memory (120) in advance, and is clarified at the stage that the USB memory (120) is attached. Moreover, in the displacement of the pointer (300), if the pointer (300) is deviated from the screen with regard to the operation for displacing in any direction on the main display or sub display, the pointer (300) is displaced from one display to the other display, and the displacement direction is maintained.

### BACKGROUND OF THE INVENTION

1. Field of the Invention

The present invention relates to an image display control apparatus, an image display system, an image display control method, a computer program product, a sub-display control apparatus for the image display system, and an image display method, which are capable of displaying images on a plurality of display apparatuses, or which are preferable in the case where the screens related to the plurality of display apparatuses are displayed on one screen or in similar cases.

2. Description of the Related Art

As this type of apparatus, there is suggested an apparatus in which a position definition file or positioning file is used (e.g. refer to Japanese Patent Application Laid Open NO. Hei 7-84725 or the like). According to a multi-display system disclosed in Japanese Patent Application Laid Open NO. Hei 7-84725 or the like (hereinafter referred to as a “first conventional technology”), if an instruction for displacing a cursor outward on a screen is given, which one of the plurality of displays the cursor is displaced to, is already determined in advance in the position definition file. Thus, the cursor can be easily displaced on the screens of the plurality of displays located at arbitrary positions.

Moreover, as this type of system, there is suggested a system in which application is shared (e.g. refer to Japanese Patent Application Laid Open NO. Hei 9-91228 or the like). According to an application sharing system disclosed in Japanese Patent Application Laid Open NO. Hei 9-91228 (hereinafter referred to as a “second conventional technology”), the bitmap image data of sharing-target application is transferred to a guest. At this time, by that the guest displays the bitmap image on its own window and transfers information about a mouse operation and a keyboard operation, performed on its own window, to a host through a network, it is possible to share the application among a plurality of computers.

Incidentally, there is also suggested a technology of activating an input from a digitizer, which is attached to all the display apparatuses, in a single multi-display environment (e.g. refer to Japanese Patent Application Laid Open NO. 2002-63107 or the like).

### SUMMARY OF THE INVENTION

In the first conventional technology, it is possible to display the cursor instructed to be displaced, outside the screen; however, if a user does not recognize the content of the position definition file in advance, it is difficult to display the cursor, which is displaced out of the screen, on a target display. Namely, the first conventional technology has such a technical problem that operating efficiency tends to reduce in displaying the image outside the screen.

In the second conventional technology, it is possible to share the application among the host and a plurality of guests; however, what is shared is only the application. It is difficult to collectively display the self-windows of the plurality of guests on the screen of the host, for example.

On the other hand, it is possible to connect the plurality of computer apparatuses to the host apparatus in terms of hardware and to display their plurality of screens on the screen of the host apparatus. In this case, however, the number of connectable apparatuses is restricted by the physical conditions of the host apparatus. Due to the restriction, if it is desired to add an apparatus which is a display target, there is no choice but to change the physical connection step by step, and the efficiency likely reduces remarkably. Namely, the second conventional technology has such a technical problem that it is difficult to display the screens of the plurality of apparatus on one screen.

In order to solve the above-mentioned problems, it is therefore an object of the present invention to provide an image display control apparatus, an image display system, an image display control method, and a computer program product, which are capable of preventing the reduction of the operating efficiency in displaying the image. Moreover, it is also an object of the present invention to provide an image display system, a sub display control apparatus for the image display system, an image display method, and a computer program product, which are capable of displaying a plurality of screens on one screen, efficiently and effectively.

<First Image Display Control Apparatus>

The above object of the present invention can be achieved by a first image display control apparatus for controlling a main display apparatus which has a main display screen for displaying an image and a sub display apparatus which has a sub display screen for displaying the image, the image display control apparatus provided with: a storing device for storing predetermined types of setting information necessary to display the image on the sub display screen, the storing device being constructed to be detachable to the image display control apparatus; a display position determining device for determining a display position of at least one portion of the image to be displaced, on the sub display screen or the main display screen, on the basis of the setting information, if an input indicating to displace the at least one portion of the image displayed on the main display screen or the sub display screen to an outside of a screen of the main display screen or the sub display screen is given, in such a condition that the storing device is attached; and a controlling device for controlling the main display apparatus or the sub display apparatus to display the at least one portion of the image to be displaced, in the determined display position.

The “image” of the present invention is a concept including visual information which can be displayed on the main display screen and the sub display screen, and it indicates the various pointers of various pointing devices, such as a mouse, and objects or the like, such as a window and an icon, about various application programs, such as work processor, spreadsheet, presentation, database, or imaging.

The “main display apparatus” and the “sub display apparatus” of the present invention are physically individual display apparatuses; however, their hardware structures may be different from each other or may be the same. For example, the display apparatuses may have various aspects, such as a plasma display apparatus, a liquid crystal display apparatus, a CRT (Cathode Ray Tube) display apparatus, and a liquid crystal projector.

The storing device, which stores therein the predetermined types of setting information, is detachably attached to the first image display apparatus of the present invention. The “setting information” herein is a concept including information necessary to display the image at least on the sub display screen. As long as such a concept is ensured, the setting information may include identification information for identifying the sub display apparatus, various information about the sub display screen (e.g. information about a display area, resolution, or the like), control information necessary to control the sub display apparatus, or authentication information for authenticating the sub display apparatus, or the like.

In such a condition that the storing device is attached, if the input indicating to displace at least one portion of the image, such as the pointer and the various windows, described above, to the outside of the screen_of the main display screen or the sub display screen, the display position on the sub display screen or the main display screen in which the at least one portion of the image to be displaced should be displayed is determined by the display position determining device.

The “input” herein is a signal, generated along with various operations which are artificially performed by a user through a predetermined inputting device. The various operations indicate a mouse operation, a keyboard operation or the like, performed by the user. Therefore, such an inputting device has various aspects, such as a mouse, a keyboard, a trackball, a touch pad, a scroll button, and a touch panel apparatus, for example. Namely, the “input indicating to displace the image”, described herein, indicates a input which is generated in performing an operation or the like for displacing the pointer from the top edge (the same is true for the bottom edge, left edge, or right edge) of the main display screen or the sub display screen to a further upper side (the same is true for a lower side, left, or right), for example.

If the display position is determined, the sub display apparatus or the main display apparatus is controlled by the controlling device to display the at least one portion of the image to be displaced, in the determined display position on the sub display screen or the main display screen.

Here, on the first image display control apparatus of the present invention, the display position determining device determines the display position, on the basis of the setting information stored in the storing device. Thus, the at least one portion of the image, which is promoted to be displaced by the input indicating to displace it to the outside of the screen on the main display screen, is displaced on the sub display screen, which is provided for the sub display apparatus associated with the storing device. Therefore, the user can perform an extremely intuitive operation, without specially paying attention to or memorizing the individual specific setting content, such as which operation corresponds to which sub display apparatus, or which sub display screen is set around the main display screen. Moreover, there is no limitation on the direction of displacing the image on the main display screen or the sub display screen. Thus, it is clearly more advantageous than the case where the displacement of the image between the main display screen and sub display screen is allowed only in a certain direction. Namely, according to the first image display control apparatus of the present invention, it is possible to prevent the reduction in the operating efficiency in displaying the image.

Incidentally, in view of the above-mentioned operation of the first image display control apparatus of the present invention, by preparing in advance the storing device corresponding to each of a plurality of sub display apparatuses, it is also possible and easy to select the proper sub display apparatus at each time.

In one aspect of the first image display control apparatus of the present invention, the setting information includes authentication information for authenticating the sub display apparatus, the image display control apparatus is further provided with an authenticating device for performing a predetermined authentication process with the sub display apparatus, on the basis of the authentication information, in such a condition that the storing device is attached, and the display position determining device determines the display position on the sub display screen, which is provided for the sub display apparatus which is authenticated as a result of the authentication process.

According to this aspect, the setting information includes the authentication information, and the authentication process is performed by the authenticating device. The above-mentioned display position is determined on the sub display screen, which is provided for the sub display apparatus authenticated as a result of the authentication process. Therefore, even if the user mistakenly attaches the storing device that is not suited to the sub display apparatus, for example, the determination of the display position is not performed on the basis of the setting information in the mistakenly attached storing device. Namely, the display quality of the image, including the displacement of the image, is ensured, and the reduction in the operating efficiency is effectively prevented. Incidentally, the authentication process may use known authentication algorithm or the like in which a key pair of a secret key and a public key is used, for example.

In another aspect of the first image display control apparatus of the present invention, the display position determining device determines the display position such that a displacement direction of the image on the main display screen corresponds to a displacement direction of the image on the sub display screen.

According to this aspect, when the at least one portion of the image is displaced from the main display screen or the sub display screen to the sub display screen or the main display screen, the displacement direction is maintained. For example, if an input indicating to displace the image which is a displacement target, such as the pointer and the window, to the right side on the main display screen and to displace it to the outside of the screen of the main display screen is given, the displacement target image is displayed with it moving to the right side, even on the sub display screen. Therefore, the user's intuitive operation is assisted, and its operationality is preferably ensured.

In another aspect of the first image display control apparatus of the present invention, the display position determining device determines the display position on the sub display screen or the main display screen, in a vertically reversed position or a horizontally reversed position with respect to the display position on the main display screen or the sub display screen, in accordance with a displacement direction of the image, if the input indicating to displace the image is given.

According to this aspect, if the direction of displacing the image is upward direction on the main display screen, in other words, if the image passes through the top edge portion of the main display screen and is displaced to the sub display screen, the image appears from the lower edge portion on the sub display screen. Therefore, the image deviated from the main display screen is displayed on the sub display screen, as if the main display screen and the sub display screen were adjacent to each other. Therefore, the operating efficiency is improved in displaying the image.

Incidentally, as described above, if the image is displaced to the vertically reversed position or the horizontally reversed position, in accordance with the displacement direction, a coordinate position in a different direction from the reversed direction is maintained, preferably. In this case, the operating efficiency can be further improved.

In another aspect of the first image display control apparatus of the present invention, it is further provided with a selecting device for selecting two display screens, if there are the plurality of sub display apparatuses, which are displacement targets of the image, from among the main display screen and a plurality of sub display screens provided for the plurality of sub display apparatuses, the display position determining device determining the display position of at least one portion of the image to be displaced, between the selected display screens, if the input indicating to displace the image is given.

According to this aspect, the two display screens, which are the displacement targets, are selected by the selecting device, from among the main display screen and the plurality of sub display screens. The selection aspect is not limited at all and may be arbitrarily determined. For example, if the order of priority is given to the individual display apparatuses on the basis of some judgment reference in advance, the display apparatus may be selected on the basis of the order of priority. Even in this case, the display position is determined on the basis of the setting information stored in the storing device, and the above-mentioned effects of the first image display control apparatus of the present invention are preferably ensured.

Incidentally, as described above, if the plurality of sub display apparatuses are provided, a plurality of setting information corresponding to the individual sub display apparatuses is provided in view of the concept of the present invention. However, the plurality of setting information may be not stored in a plurality of storing devices which correspond to the respective sub display screens in one-to-one manner. Of course, one storing device may be provided for each one sub display apparatus.

Incidentally, in this aspect, the selecting device may select the two display screens in accordance with an input indicating to specify the two display screens which are the displacement targets.

In this case, the display screen is selected in response to the input which reflects the user's will and which is performed through the various pointing devices, such as a mouse, or the keyboard or the like, for example. Therefore, if conference agenda are prepared on the main display screen, the data, such as amount of sales, is displayed on one sub display screen, and a presentation screen is displayed on another sub display screen, or in similar cases, it is also possible to temporarily stop the preparation of the conference agenda and perform the above-mentioned displacement of the image (e.g. displacement of the pointer) between the sub display screens. The selection aspect of selecting the display screen may be set as an operation mode capable of performing multiple selections in advance. In this case, the user's operation can be extremely simple.

<Second Image Display Control Apparatus>

The above object of the present invention can be also achieved by a second image display control apparatus for controlling a main display apparatus which has a main display screen for displaying an image and a sub display apparatus which has a sub display screen for displaying the image, the image display control apparatus provided with: a storing device for storing predetermined types of setting information necessary to display the image on the sub display screen, the storing device being constructed to be detachable to the image display control apparatus, the setting information including position relationship information which represents a virtual position relationship between the main display screen and the sub display screen; a judging device for judging whether or not there is the sub display screen or the main display screen in a direction toward which displacement is promoted by an input indicating to displace at least one portion of the image, on the basis of the position relationship information, if the input indicating to displace the at least one portion of the image displayed on the main display screen or the sub display screen to an outside of a screen of the main display screen or the sub display screen is given, in such a condition that the storing device is attached; and a display position determining device for determining a display position of the at least one portion of the image to be displaced, on the sub display screen or the main display screen, on the basis of the setting information, if it is judged that there is the sub display screen or the main display screen; and a controlling device for controlling the sub display apparatus or the main display apparatus to display the at least one portion of the image to be displaced, in the determined display position.

In the second image display control apparatus of the present invention, the setting information includes the position relationship information, which represents the virtual position relationship between the main display screen and the sub display screen. The “virtual position relationship” herein is different from a physical (i.e. absolute) position relationship, and it indicates the position relationship between the main display screen and the sub display screen when it is considered that the sub display screen virtually exists in one portion around the main display screen.

The judging device judges whether or not there is the sub display screen or the main display screen in the direction toward which the displacement is promoted by the input (i.e. whether or not the sub display screen or the main display screen is set so as to consider that the sub display screen or the main display screen exists), if the input indicating to displace the image is given. The display position determining device determines the display position on the sub display screen, if there is the sub display screen or the main display screen in the direction toward which the displacement is promoted. Therefore, in the second image display control apparatus, as opposed to the above-mentioned first image display control apparatus, in some cases, the image is not displaced to the sub display screen or the main display screen, in at least one portion of the range of the main display screen or the sub display screen. Therefore, considering that the setting information includes the position relationship information (i.e. the position relationship is not defined by a software process on the image display control apparatus), as occasion demands, the virtual position relationship between the main and sub display screens is already determined when the storing device is attached, and there is an extremely small possibility that the user hesitates the destination of the image. Namely, there is no change in that the destination of the image is uniquely or primarily defined by the storing device (setting information), so that the reduction in the operating efficiency is prevented, efficiently and effectively.

Incidentally, the displacement direction of the image is transmitted to the user, easily and effectively, by physically appending (e.g. by writing with a pen or the like or by putting a seal on the body of the storing device) the information which represents the position relationship with respect to the main display screen, such as “top”, “bottom”, “left”, and “right”, to each storing device, for example.

<First Image Display System>

The above object of the present invention can be also achieved by a first image display system included in a network, provided with: a control terminal; and a controlled terminal, the control terminal controlling a main display apparatus having a main display screen for displaying an image, the controlled terminal provided with: a sub display apparatus having a sub display screen for displaying the image, the control terminal further provided with: a storing device for storing predetermined types of setting information necessary to display the image on the sub display screen, the storing device being constructed to be detachable to an image display control apparatus; a display position determining device for determining a display position of at least one portion of the image to be displaced, on the sub display screen or the main display screen, on the basis of the setting information, if an input indicating to displace the at least one portion of the image displayed on the main display screen or the sub display screen to an outside of a screen of the main display screen or the sub display screen is given, in such a condition that the storing device is attached; a control-terminal-side controlling device for controlling the main display apparatus to display the at least one portion of the image to be displaced, in the determined display position, if there is the determined display position on the main display screen; a generating device for generating control information for displaying the at least one portion of the image to be displaced, in the determined display position, if there is the determined display position on the sub display screen; and a control-terminal-side communicating device for transmitting the control information to the controlled terminal through the network, the controlled terminal further provided with: a controlled-terminal-side controlling device for controlling the sub display apparatus to display the at least one portion of the image to be displaced, in the determined display position, on the basis of the transmitted control information.

The first image display control system of the present invention is included in the network and includes the control terminal and the controlled terminal.

The “network” herein preferably indicates a relatively limited communication network, such as a WAN (Wide Area Network) and a LAN (Local Area Network). However, it may be the wide area communication network, such as the Internet.

According to the first image display control system of the present invention, the control terminal is provided with: the storing device; the display position determining device; the generating device; and the control-terminal-side communicating device, and the controlled terminal is provided with: the sub display apparatus; and the controlled-terminal-side controlling device. Therefore, in a space, such as a conference room, a lecture room, and a hall, for example, it is possible to perform presentations, conferences, lectures, talks, or publication of the results of a research, or the like, without the reduction in the operating efficiency.

Incidentally, in the first image display control system of the present invention, the roles of the controlled-terminal-side controlling device, the generating device, and the communicating device are at least partially common to that of controlling device of the above-mentioned image display control apparatus of the present invention. Namely, in this case, the display content of the sub display screen is controlled indirectly through the controlled-terminal-side controlling device, which is provided for the controlled terminal.

<Image Display Control Method>

The above object of the present invention can be also achieved by an image display control method of controlling a main display apparatus and a sub display apparatus which have a main display screen and a sub display screen for displaying an image, respectively, the image display control method provided with: a display position determining process of determining a display position of at least one portion of the image to be displaced, on the sub display screen or the main display screen, on the basis of setting information, if an input indicating to displace the at least one portion of the image displayed on the main display screen or the sub display screen to an outside of a screen of the main display screen or the sub display screen is given, in such a condition that a storing device is attached, the storing device storing predetermined types of the setting information necessary to display the image on the sub display screen, the storing device being constructed to be detachable to an image display control apparatus; and a controlling process of controlling the sub or main display apparatus to display the at least one portion to be displaced, in the determined display position.

According to the image display control method of the present invention, the same effects as those of the first image display control apparatus of the present invention are realized by the operation in the various processes equivalent to the image display control apparatus of the present invention.

<First Computer Program Product>

The above object of the present invention can be also achieved by a first computer program product in a computer-readable medium for tangibly embodying a program of instructions executable by a computer provided in the above-mentioned first or second image display control apparatus of the present invention (including its various aspects), to make the computer function as the display position determining device and the controlling device.

According to the first computer program product of the present invention, the above-mentioned first or second image display control apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, or from a solid-state storage apparatus, which is detachable to the computer, such as a USB (Universal Serial Bus) memory, into the computer system, or by downloading the computer program product, which may be a carrier wave, into the computer via a communication device. More specifically, the computer program product may include computer readable codes to cause the computer (or may comprise computer readable instructions for causing the computer) to function as the above-mentioned first or second image display control apparatus of the present invention.

Incidentally, in response to the various aspects of each of the above-mentioned image display control apparatuses of the present invention, the first computer program product of the present invention can also adopt various aspects.

As explained above, according to the first image display control apparatus of the present invention, it is possible to prevent the reduction in the operating efficiency in displaying the image.

As explained above, according to the second image display control apparatus of the present invention, it is possible to display the image without the reduction in the operating efficiency.

As explained above, according to the first image display system of the present invention, it is provided with the control terminal and the controlled terminal, so that it is possible to perform conferences or the like, without the reduction in the operating efficiency.

As explained above, according to the image display control method of the present invention, it is provided with the display position determining process and the controlling process, so that it is possible to prevent the reduction in the operating efficiency in displaying the image.

As explained above, according to the first computer program product of the present invention, the computer system can function as the display position determining device and the controlling device of the various image display control apparatuses of the present invention, so that it is possible to prevent the reduction in the operating efficiency in displaying the image.

<Second Image Display System>

The above object of the present invention can be also achieved by a second image display system included in a network, provided with: a plurality of main display control apparatuses for controlling respective main display apparatuses; and a sub display control apparatus for controlling a sub display apparatus, each of the plurality of main display control apparatuses provided with: a main controlling device for controlling the main display apparatus to display a main screen, a main display data generating device for generating main display data for displaying the main screen on the sub display apparatus; and a main communicating device for transmitting the main display data to the sub display control apparatus through the network, the sub display control apparatus provided with: a sub display data generating device for generating sub display data for displaying a predetermined types of sub screen, including at least one portion of a plurality of main screens, each of which corresponds to the plurality of main display control apparatuses respectively, on the basis of the transmitted main display data; and a sub controlling device for controlling the sub display apparatus to display the sub screen in accordance with the sub display data.

According to the second image display system of the present invention, at the time of its operation, the plurality of main display apparatus is controlled to display the main screen, by each of the plurality of main display control apparatuses, respectively. The “main screen” of the present invention is a screen or image plane having contents peculiar to each of the main display control apparatuses, and it indicates a screen or image plane displayed in the display area of the main display apparatus corresponding to each of the main display control apparatuses. For example, the main screen may be an OS (Operating System) screen under a computer system environment of a personal computer (hereinafter referred to as a “PC”, as occasion demands), various application software screens which operate on the OS, or a multi-window screen in which the application software screens occupy one area on the OS screen, as various windows, or the like, for example. Alternatively, the “main screen” may be various windows themselves which expand on the various OS. Namely, the main screen may be one portion of the display area of the main display apparatus. Incidentally, the main display apparatus may have an arbitrary aspects as long as capable of displaying the main screen, and it may have a form of liquid crystal display apparatus, plasma display apparatus, CRT (Cathode Ray Tube) display apparatus, liquid crystal projector, or the like.

Incidentally, the main display control apparatus in the second image display system of the present invention may be unified with the main display apparatus, such as a laptop type PC, for example, or it may have a form of various controllers or the like for controlling the main display apparatus, such as individually constructed various display apparatuses.

In each of the plurality of main display control apparatuses, the main display data is generated by the main display data generating device. The main display data is data, such as a RGB signal, for displaying the main screen on the sub display apparatus. It may be data itself for displaying the main screen on the main display apparatus, or it may be data corrected to be consistent with the features of the sub display apparatus. Alternatively, it may be data obtained by compressing the above data in a form suitable for transmission on the network, as occasion demands. The main display data, generated on each of the plurality of main display control apparatuses, is transmitted to the sub display control apparatus through the network, by the main communicating device.

On the other hand, on the sub display control apparatus side, the sub display data for displaying the sub screen is generated on the basis of the main display data, which is individually transmitted from each main display control apparatus. The sub controlling device controls the sub display apparatus to display the sub screen in accordance with the sub display data.

The “sub screen” herein is a concept including a screen or image plane including at least one portion of the plurality of main screens which correspond to the respective plurality of main display control apparatuses. For example, it may be such a screen that all the main screens, corresponding to the main display control apparatuses which transmit the main display data, are uniformly arranged on the display area. Alternatively, it may be such a screen that only the main screens selected from the plurality of main screens in accordance with some judgment reference given in advance are arranged. Such a judgment reference may be determined so that the main screen to be displayed on the sub screen can be selected for objective reasons, experimentally, experientially, or on the basis of simulations, or the like, in advance.

Incidentally, there is no limitation on the display aspect of displaying the main screen on the sub screen. For example, the main screen may be displayed as the window or the like, according to the various OS or the like. In this case, the arrangement aspect of the main screens on the sub screen can be arbitrarily set on the user's side. For example, it is possible and easy to arrange at least one portion of the main screens of the main display apparatuses, with them overlapped, on the sub screen, or it is possible and easy to change the size thereof.

Moreover, the main screen to be included in the sub screen and its individual arrangement aspect or the like can be changed at each time in real time, in accordance with the use environment of the image display system, which changes every second, for example, in accordance with the progress of a conference or the like, for example.

As explained above, according to the second image display system of the present invention, at least one portion of the main screens, which are displayed on the corresponding main display apparatuses by the plurality of main display control apparatuses, are collectively displayed as the sub screen on one sub display apparatus. In this case, the sub display apparatus is controlled by the sub display control apparatus for controlling the display content of the sub screen. Moreover, the sub display control apparatus and each of the main display control apparatuses are included in the network, such as the LAN, for example. Therefore, as compared to the case where each of the main display control apparatuses and the sub display control apparatus are connected to each other through a video signal supply line, such as a RGB cable, or similar cases, the number of the main display control apparatuses that the sub display control apparatus can support, can be remarkably increased. Moreover, the display aspect of each of the main display control apparatuses (i.e. simply the main screen) on the sub screen, which can be remarkably increased as described above, is determined by the sub display control apparatus which uniformly or primarily manages them, so that it is efficient. Namely, according to the second image display system of the present invention, it is possible to display the plurality of screens as one screen, efficiently and effectively.

In one aspect of the second image display system of the present invention, the sub display control apparatus is further provided with an arrangement aspect determining device for determining an arrangement aspect of the at least one portion of the plurality of main screens included in the sub screen, on the basis of at least one of (i) number of the at least one portion of the plurality of main screens included in the sub screen and (ii) priority of the at least one portion of the plurality of main screens included in the sub screen.

According to this aspect, the arrangement aspect of the at least one portion of the plurality of main screens included in the sub screen is determined on the basis of at least one of the number and the priority of the at least one portion of the plurality of main screens included in the sub screen, by the arrangement aspect determining device. Thus, it is possible to display the plurality of screens as one screen, efficiently and effectively.

Incidentally, the “number of the at least one portion of the plurality of main screens included in the sub screen” may be equal to the number of the main display control apparatuses, if it is set in advance such that all the main screens related to the main display control apparatuses included in the network are included in the sub screen, for example. Moreover, the “priority” is a concept including the judgment reference to rank the main screens. It may be given in advance, or it may be given, individually and specifically, in accordance with the use status of the image display system at each time. Moreover, the priority may be specified from the individual main display control apparatuses, or may be specified on the sub display control apparatus side. For example, the priority may be set as an order of the connection to the network, or the high priority may be given to the main screen on which some operation (e.g. instruction or input operation by using the mouse and the keyboard or the like) or the like is performed on the main display control apparatus side.

In another aspect of the second image display system of the present invention, each of the plurality of main display control apparatuses is further provided with: a storing device for storing authentication information for authenticating the sub display apparatus, the storing device being constructed to be detachable to each of the plurality of main display control apparatuses; and an authenticating device for performing an authentication process between each of the plurality of main display control apparatuses and the sub display apparatus, on the basis of the authentication information, in such a condition that the storing device is attached, and the sub display data generating device generates the sub display data, on the basis of the main display data transmitted from the main display control apparatus which is authenticated as a result of the authentication process.

According to this aspect, the second main display control apparatus is provided with the detachable storing device, and the authentication information for authenticating the sub display apparatus is stored in the storing device. The “authentication information” herein is conceptually equal to what is described in the first main display control apparatus. It is information for identifying whether or not the sub display apparatus is of a type set in advance, and it indicates ID information given to each sub display apparatus, ID information which is different in each type of the sub display apparatus, or the like. Alternatively, it may be key information or the like including a public key and a secret key, which is set in advance with the sub display apparatus.

The authenticating device performs the authentication process between each of said plurality of main display control apparatuses and the sub display apparatus, on the basis of the authentication information. Such an authentication process may have various forms in accordance with the aspect of the authentication information. For example, if the authentication information is the above-mentioned key information, the known key authentication algorithm or the like may be adopted. Alternatively, as a relatively simple form, the authentication may be performed by whether or not the ID information individually given to the sub display apparatus and the ID information stored as the authentication information in the storing device match each other. In this case, the storing device may be associated in advance with the sub display apparatus (or all the display apparatus which can be the sub display apparatus), in a manner of one-to-one, one-to-plurals, plurals-to-one, or plurals-to-plurals, so that the authentication is performed, relatively easily.

On the other hand, the sub display data generating device generates the sub display data, on the basis of the main display data transmitted from the main display control apparatus authenticated. Therefore, according to this aspect, it is possible to easily give qualification for the participation in the image display system, which improves the quality and security of the image display system.

Incidentally, considering that the authentication information is information for specifying the sub display apparatus, the storing device may further store therein information for defying various display features, such as the size of the display area and the resolution of the sub display apparatus that the authentication information corresponds to, in addition to the authentication information. In this case, it is also possible and easy to generate the main display data suitable for the display on the sub display apparatus.

Moreover, if the authentication is performed through the detachable storing device, as described above, the authentication process may be performed, automatically or semi-automatically, when the storing device is attached to the main display control apparatus, for example. Moreover, the main display data may be transmitted, automatically or semi-automatically, depending on the result of the authentication process. In the same manner, the transmission of the main display data may be stopped when the storing device is detached from the main display control apparatus. Namely, the action itself of attaching/detaching the storing apparatus may be used as a sign of performing the authentication process, transmitting or stopping the transmission of the main display data, or the like. In this case, it is possible to give the user a clear operational feeling, and the complicated operation is no longer necessary on the user side, so that it is efficient.

In another aspect of the second image display system of the present invention, the main screen includes an instruction image for instructing a position on the main screen, each of the plurality of main display control apparatuses is further provided with: a virtual position specifying device for specifying a virtual position of the instruction image on an outside of the main screen, if an input indicating to displace the instruction image to the outside of the main screen is given; and a virtual position data generating device for generating virtual position data corresponding to the virtual position, the main communicating device transmits the virtual position data to the sub display control apparatus through the network, the sub display control apparatus is further provided with: an actual position specifying device for specifying an actual position of the instruction image on the sub screen, represented by the transmitted virtual position data; a display position determining device for determining a display position of the instruction image on the main screen to which the actual position belongs, from among the at least one portion of the plurality of main screens included in the sub screen, on the basis of the actual position; a display position data generating device for generating display position data which represents the determined display position; and a sub communicating device for transmitting the display position data to the main display control apparatus corresponding to the main screen to which the actual position belongs, through the network, and the main controlling device of the main display control apparatus corresponding to the main screen to which the actual position belongs, controls arrangement of the instruction image on the main screen, on the basis of the transmitted display data.

The “instruction image” of the present invention is a concept including the image for instructing the position on the main screen, and it preferably indicates a pointer of various pointing devices, such as a mouse, a keyboard, a trackball, and a touch pad, and a cursor of the keyboard, or the like, for example.

Here, if the input indicating to displace the instruction image to the outside of the main screen is given, the virtual position of the instruction image outside the screen is specified by the virtual position specifying device. Moreover, the virtual position data corresponding to the virtual position is generated by the virtual position data generating device. The virtual position data is transmitted to the sub display control apparatus. Incidentally, there is no limitation on the aspect of specifying the virtual position as long as capable of specifying the virtual position, and it is arbitrarily set on the basis of the display aspect of displaying the instruction image, or the like, for example. For example, the virtual displacement amount of the pointer may be calculated on the basis of an electrical signal which represents the operation amount of the mouse or the like, and the virtual position may be specified from the coordinate position of the pointer at that time point. Moreover, the virtual position is not necessarily clearly represented by the coordinates, and it may be the above-mentioned operation amount of the mouse or the like, or the displacement amount of the pointer or the like, for example.

The “input” herein is the same concept as described above, and it indicates the input for performing an operation or the like for displacing the pointer from the top edge (the same is true for the bottom edge, left edge, or right edge) of the main or sub display screen to a further upper side (the same is true for a lower side, left, or right) is performed, for example.

On the other hand, on the sub display control apparatus, the actual position on the sub screen is specified on the basis of the virtual position data. The display position determining device determines the display position of the instruction image on the main screen to which the actual position belongs (except at least the main screen corresponding to the main display control apparatus to which the input indicating to displace the instruction image is given), on the basis of the actual position. The “display position” herein indicates the coordinates or the like, which represent the absolute position on the relevant main screen, for example. The display position is transmitted to the main display control apparatus corresponding to the relevant main screen, as the display position data.

Here, on the main display control apparatus corresponding to the relevant main screen, the main controlling device controls the arrangement of the instruction image, on the basis of the display position data. Therefore, on the relevant main screen, the position of the instruction information is operated, in response to the input operation from another main display control apparatus included in the network. Namely, according to this aspect, it is possible to point a desired position on the main screen arranged on the sub screen, on each of the main display control apparatuses included in the network, which is effective and efficient.

Incidentally, if the main screens are displayed as the windows or the like, on the sub screen, as described above, the main screens may be overlapped, or disposed separately from each other. In this case, however, the boundary of the main screens which are overlapped or separated is discontinuous. Therefore, the coordinates of the display position determined by the display position determining device are not necessarily continuous, before or after the input indicating to displace the instruction image to the outside of the screen is given. Moreover, if the main screens are overlapped on the sub screen, the overlap aspect may be changed such that the main screen that is an operation target at the current time point (e.g. the main screen which is the destination in the case where the input is given on one main screen indicating to displace the instruction image out of the screen) is disposed in front.

In another aspect of the second image display system of the present invention, the sub display control apparatus is further provided with a drawing device for drawing an image, which is different from that of the main screen, on the sub screen, in accordance with a predetermined input.

According to this aspect, the sub display control apparatus is provided with the drawing device, and the image different from the main screen can be drawn on the sub screen in accordance with the predetermined input, so that it is more effective. There is no limitation on the aspect of the drawing device as long as the drawn image and the sub screen overlap each other and can be visually recognized. For example, if a drawing panel is provided so as to overlap the display panel portion of the sub display apparatus for displaying the sub screen, the drawing device draws the image on the drawing panel. By this, visual recognition can be performed as if the image were drawn on the sub screen.

Moreover, considering that the data about the main screen passes through the sub display control apparatus once, the sub display control apparatus further controls the drawing device in accordance with a predetermined drawing input, performed on each of the main screens. In this case, for example, a display color or the like may be changed as occasion demands, so as to visually judge which main display control apparatus performs the input.

<Sub Display Control Apparatus for Image Display System>

The above object of the present invention can be also achieved by a sub display control apparatus for an image display system, included in a network and provided for an image display system including a plurality of main display control apparatuses, each of the plurality of main display control apparatuses (i) controlling a plurality of main display apparatuses and (ii) provided with: a main controlling device for controlling the plurality of main display apparatus to display a main screen; a main display data generating device for generating main display data for displaying the main screen; and a main communicating device for transmitting the main display data through the network, the sub display control apparatus for an image display system provided with: a sub display data generating device for generating sub display data for displaying a predetermined types of sub screen including at least one portion of a plurality of main screens, each of which corresponds to the plurality of main display control apparatuses respectively, on the basis of the transmitted main display data; and a sub controlling device for controlling the sub display apparatus to display the sub screen in accordance with the sub display data.

According to the sub display control apparatus for an image display system of the present invention, it contributes to the same effects as those of the sub display-control apparatus in the above-mentioned second image display system of the present invention.

<Image Display Method>

The above object of the present invention can be also achieved by an image display method in an image display system included in a network, provided with: a plurality of main display control apparatuses for controlling respective main display apparatuses; and a sub display control apparatus for controlling a sub display apparatus, in each of the plurality of main display control apparatuses, the method provided with: a main controlling process of controlling the main display apparatus to display a main screen, a main display data generating process of generating main display data for displaying the main screen on the sub display apparatus; and a main communicating process of transmitting the main display data to the sub display control apparatus through the network, in the sub display control apparatus, the method provided with: a sub display data generating process of generating sub display data for displaying a predetermined types of sub screen, including at least one portion of a plurality of main screens, each of which correspond to the plurality of main display control apparatuses respectively, on the basis of the transmitted main display data; and a sub controlling process of controlling the sub display apparatus to display the sub screen in accordance with the sub display data.

According to the image display method of the present invention, the same effects as those of the second image display system of the present invention are realized by the operation in the various processes equivalent to the second image display system of the present invention.

<Second Computer Program Product>

The above object of the present invention can be also achieved by a second computer program product in a computer-readable medium for tangibly embodying a program of instructions executable by a computer provided in the above-mentioned second image display system of the present invention (including its various aspects), to make the computer function as the main display control apparatus.

According to the second computer program product of the present invention, the above-mentioned main display control apparatus of the second image display system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, or from a solid-state storage apparatus, which is detachable to the computer, such as a USB (Universal Serial Bus) memory, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned main display control apparatus of the second image display system of the present invention.

Incidentally, in response to the various aspects of the above-mentioned first or second image display system of the present invention, the second computer program product of the present invention can also adopt various aspects.

<Third Computer Program Product>

The above object of the present invention can be also achieved by a third computer program product in a computer-readable medium for tangibly embodying a program of instructions executable by a computer provided in the above-mentioned second image display system of the present invention (including its various aspects), to make the computer function as the sub display control apparatus.

According to the third computer program product of the present invention, the above-mentioned sub display control apparatus of the second image display system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, or from a solid-state storage apparatus, which is detachable to the computer, such as a USB (Universal Serial Bus) memory, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned sub display control apparatus of the second image display system of the present invention.

Incidentally, in response to the various aspects of the above-mentioned first or second image display system of the present invention, the third computer program product of the present invention can also adopt various aspects.

As explained above, according to the second image display system of the present invention, it is provided with the main display control apparatus and the sub display control apparatus, so that it is possible to display the plurality of screens on one screen, efficiently and effectively.

As explained above, according to the sub display control apparatus for the image display system of the present invention, it is provided with the sub display data generating device and the sub controlling device, so that it is possible to preferably realize the sub display control apparatus in the image display system of the present invention.

As explained above, according to the image display method of the present invention, it is possible to display the plurality of screens on one screen, efficiently and effectively, by the operation in each process equivalent to respective one of the devices of the second image display system of the present invention.

As explained above, according to the second computer program product of the present invention, the computer system is made function as the main display control apparatus of the second image display system of the present invention, so that it is possible to display the plurality of screens on one screen, efficiently and effectively.

As explained above, according to the third computer program product of the present invention, the computer system is made function as the sub display control apparatus of the second image display system of the present invention, so that it is possible to display the plurality of screens on one screen, efficiently and effectively.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram showing an image display system in a first embodiment of the present invention;

FIG. 2 is a schematic diagram showing setting information stored in a USB memory, in the image display system shown in FIG. 1;

FIG. 3 is a flowchart showing an image displacement process performed by a control device of a host computer, in the image display system shown in FIG. 1;

FIG. 4 is a schematic diagram showing image displacement in the image displacement process;

FIG. 5 is a conceptual view showing an image display system in a second embodiment of the present invention;

FIG. 6 is a conceptual view showing an image display system in a third embodiment of the present invention;

FIG. 7 is a conceptual view showing an image display system in a fourth embodiment of the present invention;

FIG. 8 is a block diagram showing the personal computer in the image display system shown in FIG. 7;

FIG. 9 is a block diagram showing the display controller in the image display system shown in FIG. 7;

FIG. 10 is a flowchart showing an image sharing process;

FIG. 11 is a schematic diagram showing screen display in the image display system shown in FIG. 7;

FIGS. 12 are schematic diagrams showing variations of arrangement of shared screens on a share screen.

FIGS. 13 are schematic diagrams showing the forcing operation of a pointer;

FIGS. 14 are schematic diagrams showing display aspects of arrangement of shared screens on a share screen.

FIG. 15 is a block diagram showing a display controller in a fifth embodiment;

FIG. 16 is a schematic diagram showing a share screen in the fifth embodiment; and

FIG. 17 is a schematic diagram showing a share screen in a modified example of the fifth embodiment.

### DETAILED DESCRIPTION OF THE PREFERRED EMBODIMENTS

Hereinafter, the preferred embodiments of the present invention will be explained with reference to the drawings.

### First Embodiment

<Structure of Embodiment>

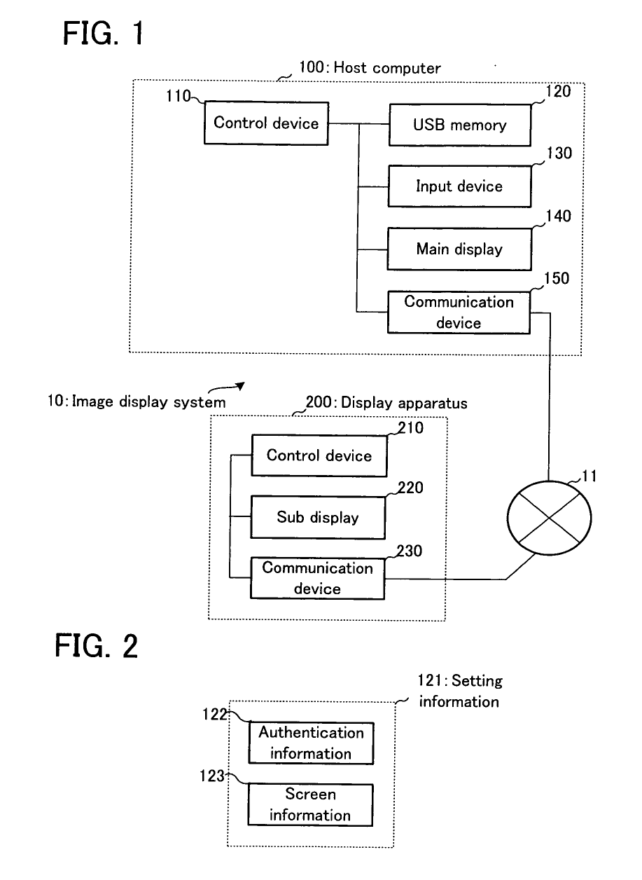

Firstly, with reference to FIG. 1, the structure of an image display system in the first embodiment of the present invention will be explained. FIG. 1 is a block diagram showing an image display system 10.

In FIG. 1, the image display system 10 is one example of the “image display system” of the present invention, in which a host computer 100 and a display apparatus 200 are included in a network 11. The network 11 is a LAN network installed in a facility, such as an office, for example.

The host computer 100 is a laptop type personal computer, and it is constructed to function as one example of the “control terminal” and the “image display control apparatus” of the present invention. The host computer 100 is provided with: a control device 110; a USB memory 120; an input device 130; a main display 140; and a communication device 150.

The control device 110 is provided with a CPU (Central Processing Unit), a ROM (Read Only Memory), and a RAM (Random Access Memory) or the like. It is a controlling unit for controlling all the operations of the host computer 100, and it is constructed to function as one example of the “display position determining device” and the “controlling device” of the present invention, or one example of the “control-terminal-side controlling device” of the present invention.

The USB memory 120 is one example of the “storing device” of the present invention, and it is constructed to be detachable to the host computer 100. In the attached condition to the host computer 100, the USB memory 120 is constructed to perform data communication based on the USB standard, with the host computer 100. The USB memory 120 stores therein an application program about an image displacement process, described later and setting information 121 about a display apparatus 200. Incidentally, the setting information 121 will be described later.

The input device 130 is a general input device, equipped with a mouse and a keyboard or the like. In FIG. 1, a not-illustrated user can give input to the host computer 100 through the input device 130, as occasion demands.

The main display 140 is a liquid crystal display apparatus, which is provided for the host computer 100 and which is one example of the “main display apparatus” of the present invention. Namely, the display panel device of the main display panel 140 is one example of the “main display screen” of the present invention. Incidentally, in the explanation below, unless otherwise noted, the main display 140 is treated as one example of the “main display screen” of the present invention, as a matter of convenience.

The communication device 150 is a communication interface for performing data communication with the display apparatus 200 through the network 11.

The display apparatus 200 is a relatively large plasma display apparatus, mounted in the same space as that in which the host computer 100 is mounted, such as a conference room. It is one example of the “controlled terminal” of the present invention. The display apparatus 200 is provided with: a control device 210; a sub display 220; and a communication device 230.

The control device 210 is constructed to display an image on the sub display 220 on the basis of control information transmitted from the host computer 100, and it is one example of the “controlled-terminal-side controlling device” of the present invention.

The sub display 220 is a unit constituting the display screen of the display apparatus, and it is one example of the “sub display screen” of the present invention.

The communication device 230 is a communication interface for receiving data from the host computer 100 through the network 11.

Next, with reference to FIG. 2, the details of the setting information 121 stored in the USB memory 120 will be explained. FIG. 2 is a schematic diagram showing the setting information 121. Incidentally, in FIG. 2, the repeated points of FIG. 1 carry the same numerical references, and the explanation thereof will be omitted, as occasion demands.

In FIG. 2, the setting information 121 includes authentication information 122 and screen information 123. The authentication information 122 is ID information for identifying the sub display 220, and the screen information 123 is information about the size of a display area and resolution or the like of the display (i.e. the sub display 220) corresponding to the authentication information 122.

<Operation of Embodiment>

In the host computer 100, the control device 110 can execute an application program stored in the USB memory 120, and can perform an image displacement process for displacing an image between the host computer 100 and the display apparatus 200. Hereinafter, as the operation example of the first embodiment, the details of the image displacement process will be explained.

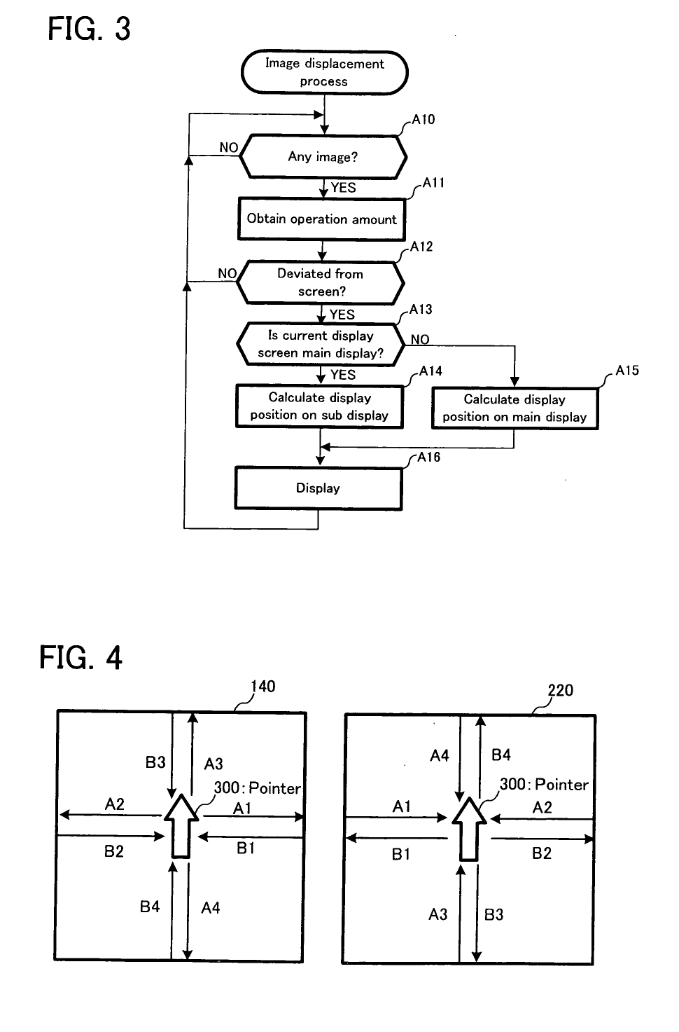

Firstly, with reference to FIG. 3, a flow of the image displacement process will be explained. FIG. 3 is a flowchart showing the image displacement process.

In FIG. 3, the control device 110 judges whether or not an image which can be operated to be displaced (i.e. one example of the “image” of the present invention) is displayed on the main display 140 or the sub display 220 (step A10). Incidentally, before this judgment or the like, the control device 110 performs an authentication process using the above-mentioned authentication information 122, and specifies that the display which is a target for the image displacement process is the sub display 220. At this time, if there is no authentication, it is recognized that there is no display which is the target for image displacement process. Incidentally, since the authentication process is known, the illustration thereof is omitted in order to prevent the complication of the drawing.

If the image which can be operated to be displaced is not displayed on any of the displays (the step A10: NO), the control device 110 repeatedly performs the process in the step A10 and controls the process in a waiting condition. On the other hand, if the image which can be operated to be displaced is displayed (the step A10: YES), the control device 110 obtains the operation amount of the input device 130 (step A11). Moreover, the control device 110 judges whether or not the image, which is currently displayed on the main display 140 or the sub display 220, is displaced to an outside of (i.e. is deviated from) the screen or image plane of the corresponding display, on the basis of the obtained operation amount (step A12).

If the image is not displaced to the outside of one of the screen (the step A12: NO), the control device 110 does not displace the image, and returns the process to the step A10, and repeats a series of processes. If it is judged that the image is displaced to the outside of the screen (the step A12: YES), the control device 110 judges whether or not the display on which the image is currently displayed is the main display 140 (step A13).

If the display on which the image is currently displayed (i.e. the screen to which such indication that the image is displaced to the outside of the screen is given as an input) is the main display 140 (the step A13: YES), the control device 110 calculates the display position on the sub display 220 of the image which has been displaced to the outside of the screen (i.e. the outside of the main display 140) (step A14). On the other hand, if the display on which the image is currently displayed is not the main display 140 (i.e. the display on which the image is currently displayed is the sub display 220) (the step A13: NO), the control device 110 calculates the display position on the main display 140 of the image which has been displaced to the outside of the screen (i.e. the outside of the sub display 220) (step A15).

After calculating the display position, the control device 110 displays the image which has been displaced to the outside of the screen, on the calculated display position (step A16). After displaying the image, the control device 110 returns the process to the step A10 and repeats a series of operations.

Now, with reference to FIG. 4, the details of the image displacement will be explained. FIG. 4 is a schematic diagram showing the image displacement. Incidentally, in FIG. 4, the repeated points of FIG. 1 carry the same numerical references, and the explanation thereof will be omitted, as occasion demands.

FIG. 4 shows the main display 140 on the left and the sub display 220 on the right. Moreover, it is assumed that the image, which is the displacement target in the above-mentioned image displacement process, is a pointer 300 corresponding to the operation using a mouse or the like.

Now, as the direction of displacing the pointer 300 from the main display 140 to the sub display 220 in the image displacement process, directions of illustrated arrows A1, A2, A3, and A4 corresponding to the right, the left, the top, and the bottom, respectively, are considered. In the first embodiment, the image is displaced such that its displacement direction is maintained on both the main display 140 and the sub display 220. Namely, if it is desired to displace the pointer 300 to the outside of the screen of the main display 140 by displacing the pointer 300 toward the illustrated A1 direction, the pointer 300 is displaced toward the illustrated A1 direction on the sub display 220. In the same manner, if the pointer 300 is displaced toward the illustrated A2, A3, and A4 directions to thereby displace the pointer 300 to the outside of the screen of the main display 140, the pointer 300 is displaced toward each of the illustrated A2, A3, and A4 directions on the sub display 220, respectively. The same is true for the case where the pointer 300 is displaced from the sub display 220 to the main display 140. In response to the motion of the pointer 300 toward illustrated B1, B2, B3, and B4 directions on the sub display 220, the pointer 300 is displaced toward the B1, B2, B3, and B4 directions on the main display 140, respectively.

Therefore, in calculating the display position in the above-mentioned image displacement process, the control device 110 performs a coordinate conversion process so as to reverse the coordinates which represent the display position on the destination display, in the horizontal or vertical direction, in response to the displacement direction of the pointer 300, with reference to the screen information 123 included in the setting information 121. By performing the coordinate conversion in the host computer 100, the image is displaced, as if the sub display 220 existed surrounding the main display 140 or the main display 140 existed surrounding the sub display 220.

Incidentally, in the first embodiment, the image display control is performed by the control device 110. Therefore, with regard to the display control of the main display 140, the control device 110 can directly control the main display 140. Moreover, in the display control of the sub display 220, display position information, including information about the above-mentioned converted coordinates, and information for displaying the image to be displayed (e.g. the pointer 300, etc.), or the like are transmitted, as the control information, to the display apparatus 200 through the network 11. The control device 210 of the display apparatus 200 controls the display content of the sub display 220, on the basis of the control information obtained through the communication device 230.

As described above, according to the image display system 10 in the first embodiment, if the user desires to displace the image from one display to the other display, it is only necessary to displace the image to the outside of a frame portion (i.e. the outside of the end edge portion) which is closest to the current display position of the image without paying attention to a virtual position relationship between the main display and the sub display, for example, and the user can perform an extremely intuitive and efficient operation. Namely, it is possible to prevent the reduction in the operating efficiency in displaying the image.

Incidentally, the user may think that the image displacement in the first embodiment is complicated, in some cases. Therefore, in preparation for such a case, a position relationship between the main display 140 and the sub display 220 may be defined in terms of software within the host computer 100, regardless of the setting information 121, and the image may be set to be displaced only in a direction according to the position relationship.

### Second Embodiment

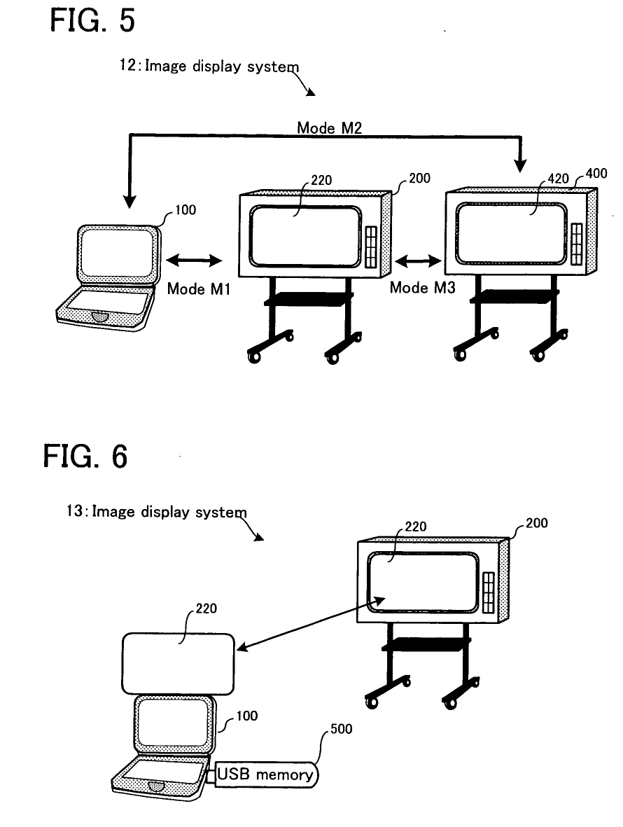

The image display system 10 in the first embodiment has only one display apparatus 200, as the sub display screen of the present invention. However, of course, there may be a plurality of display apparatuses 200. The second embodiment of the present invention, corresponding to the above case, will be explained with reference to FIG. 5. FIG. 5 is a conceptual view showing an image display system 12. Incidentally, in FIG. 5, the repeated points of FIG. 1 carry the same numerical references, and the explanation thereof will be omitted, as occasion demands.

In FIG. 5, the image display system 12 is provided with: the host computer 100; the display apparatus 200; and a display apparatus 400.

The display apparatus 400 is a display apparatus, provided with a sub display 420 whose hardware structure is the same as that of the sub display 220, and has such a structure that the authentication information held by the host computer 100 (i.e. the USB memory 120) is different from that of the display apparatus 200, of course. Incidentally, as the display apparatus that is the target for the image displacement process is added more, two types of USB memories are attached or the USB memory having two types of setting information 121 is attached to the host computer 100; however, the illustration thereof is omitted.

Now, there are three types of combinations each of which can realize the image displacement, as in the first embodiment. On the host computer 100, image displacement modes corresponding to the three types of combinations are provided in advance. Namely, they are a mode M1 corresponding to a combination of the main display 140 and the sub display 220, a mode M2 corresponding to a combination of the main display 140 and the sub display 420, and a mode M3 corresponding to a combination of the sub display 220 and the sub display 420.

In the second embodiment, it is possible to select one image displacement mode, in response to an input operation from the input device 130, from among the three types of image displacement modes. Therefore, in accordance with the proceedings of an event using the image display system, such as a conference, it is possible to select a proper display, as occasion demands, and it is possible to effectively prevent the reduction in the operating efficiency.

### Third Embodiment

In the first and second embodiments, if the operation of displacing the image to the outside of the screen is performed on one display, the image is displaced onto another display, independently of the displacement direction; however, the image displacement direction is not always limited to all the directions. Such a third embodiment of the present invention will be explained with reference to FIG. 6. FIG. 6 is a schematic diagram showing an image display system 13 in the third embodiment of the present invention. Incidentally, in FIG. 6, the repeated points of FIG. 5 carry the same numerical references, and the explanation thereof will be omitted, as occasion demands.

In FIG. 6, the image display system 13 is the same as the image display system 10 in the point that it is provided with the host computer 100 and the display apparatus 200, but it is different from the first embodiment in the point that the host computer 100 is provided with a USB memory 500.

The USB memory 500 has position information (not illustrated), in addition to the authentication information 122 and the screen information 123 described above, as the setting information. The position information is information for defying the virtual position relationship between the main display 140 and the sub display 220. The virtual position relationship is fixed to each USB memory. In the third embodiment, it is assumed that the sub display 220 is located above the main display 140 (i.e. the sub display 220 is located on upper side of the main display 140), for example (refer to FIG. 6).

In this case, the virtual position relationship between the main display 140 and sub display 220 is defined in the USB memory 500, so that when the image is displaced toward a direction which does not comply with the virtual position relationship (e.g. horizontal direction in FIG. 6), the control device 110 does not displace the image even if the operation amount of the inputting device, such as a mouse, allows the image to be displaced to the outside of the screen. In this case, typically, the image such as the pointer is displayed in the condition that it sticks to the left frame (i.e. the left end edge portion) or the right frame (i.e. the right end edge portion) of the main display 140 or sub display 220.

In the third embodiment, the image displacement is allowed only in such a limited direction, and as compared to the first and second embodiments, the degree of freedom about the image displacement is limited. However, when the USB memory 500 is attached, the position relationship between the main display 140 and the sub display 220 is fixed, so that there is a relatively low possibility of the reduction in the operating efficiency, such as the user making a mistake in the setting of the host computer 100 side. Namely, the reduction in the operating efficiency is prevented by providing the information for defying the virtual position relationship between the both displays, as one portion of the setting information, within the USB memory 500, as described above. Moreover, considering that the user also certainly recognizes in advance the image displacement direction through the selection and the attachment of the USB memory 500, the apparently complicated operation, as shown in the first and second embodiments, are no longer necessary, and even a user who is not used to the operation of the image display system does not reduce the operating efficiency, which is preferable.

### Fourth Embodiment

<Structure of Embodiment>

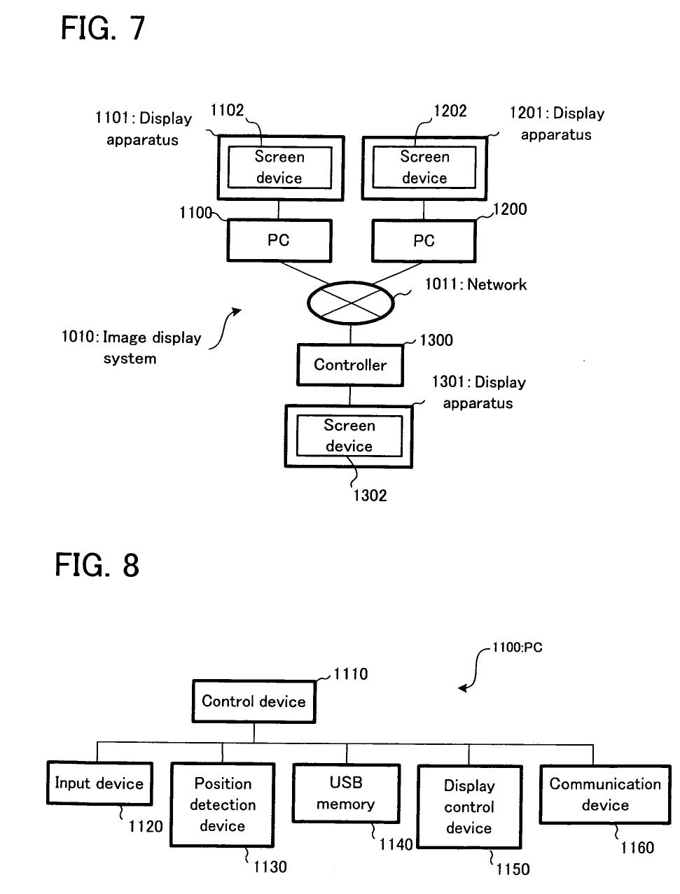

Next, with reference to FIG. 7, the structure of an image display system in the fourth embodiment of the present invention will be explained. FIG. 7 is a conceptual view showing an image display system 1010.

In FIG. 7, the image display system 1010 is one example of the “image display system” of the present invention, in which a personal computer 1100 (hereinafter referred to as a “PC 1100”, as occasion demands), a personal computer 1200 (hereinafter referred to as a “PC 1200”, as occasion demands), and a display controller 1300 (hereinafter referred to as a “controller 1300”, as occasion demands) are included in the network 11, which is a LAN network.

A display apparatus 1101 and a display apparatus 1201 are connected to the PC 1100 and the PC 1200, respectively. The display apparatuses 1101 and 1201 are constructed as liquid crystal display apparatuses, and they are another example of the “main display apparatus” of the present invention, provided with screen devices 1102 and 1202, which are information display areas, respectively. Moreover, the PC 1100 and the PC 1200 are one example of the “main display control apparatus” of the present invention.

On the other hand, a display apparatus 1301 is connected to the controller 1300. The display apparatus 1301 is a plasma display apparatus, and it is provided with a screen device 1302 larger than the above-mentioned screen devices 1102 and 1202, as the information display area. The display apparatus 1301 is one example of the “sub display apparatus” of the present invention. Incidentally, the controller 1300 is one example of the “sub display control apparatus” and the “sub display control apparatus for the image display system” of the present invention.

Next, with reference to FIG. 8, the detailed structure of the PC 1100 will be explained. FIG. 8 is a block diagram showing the PC 1100. Incidentally, in FIG. 8, the repeated points of FIG. 7 carry the same numerical references, and the explanation thereof will be omitted, as occasion demands. Moreover, the PC 1100 and the PC 1200 have the same structure in terms of hardware, and the PC 1200 will be explained at the same time with the explanation of the PC 1100.

In FIG. 8, the PC 1100 is provided with: a control device 1110; an input device 1120; a position detection device 1130; a USB memory 1140; a display control device 1150; and a communication device 1160.

The control device 1110 is provided with a CPU (Central Processing Unit), a ROM (Read Only Memory), and a RAM (Random Access Memory) or the like. It is a controlling unit for controlling all the operations of the PC 1100, and it is constructed to function as one example of the “main controlling device”, the “main display data generating device”, the “authenticating device”, and the “virtual position data generating device” of the present invention.

The input device 1120 is a general input device, equipped with a mouse and a keyboard or the like. A not-illustrated user can give various inputs to the PC 1100 through the input device 1120, as occasion demands.

The position detection device 1130 is a position detecting unit for detecting the display position of a pointer or cursor (i.e. one example of the “instruction image” of the present invention), which represents an input position through the input device 1120. It is constructed to function as one example of the “virtual position specifying device” of the present invention.

The USB memory 1140 is one example of the “storing device” of the present invention, and it is a storage apparatus, constructed to be detachable to the PC 1100. In the attached condition to the PC 1100, the USB memory 1140 is constructed to perform data communication based on the USB standard, with the PC 1100. The USB memory 1140 stores therein an application program for assisting an image sharing process described later and the authentication information or the like about a display apparatus 1301.

The display control device 1150 is a display controlling unit for controlling the display apparatus 1101 so as to display a shared screen or image plane W1 (i.e. one example of the “main screen” of the present invention) on the screen device 1102. It is constructed to function as one example of the “main controlling device” of the present invention, together with the control device 1100.

The communication device 1160 is a communication interface for performing data communication with the controller 1300 through a network 1011. It is one example of the “main communicating device” of the present invention.

Incidentally, correspondingly to each device of the above-mentioned PC 1100, it is assumed that the PC 1200 is provided with: a control device 1210; an input device 1220; a position detection device 1230; a USB memory 1240; a display control device 1250; and a communication device 1260, which are not illustrated. Moreover, it is also assumed that a shared screen “W2” (i.e. another example of the “main screen” of the present invention”) is displayed on the screen device 1202 of the display apparatus 1201 by the display control device 1250 of the PC 1200.

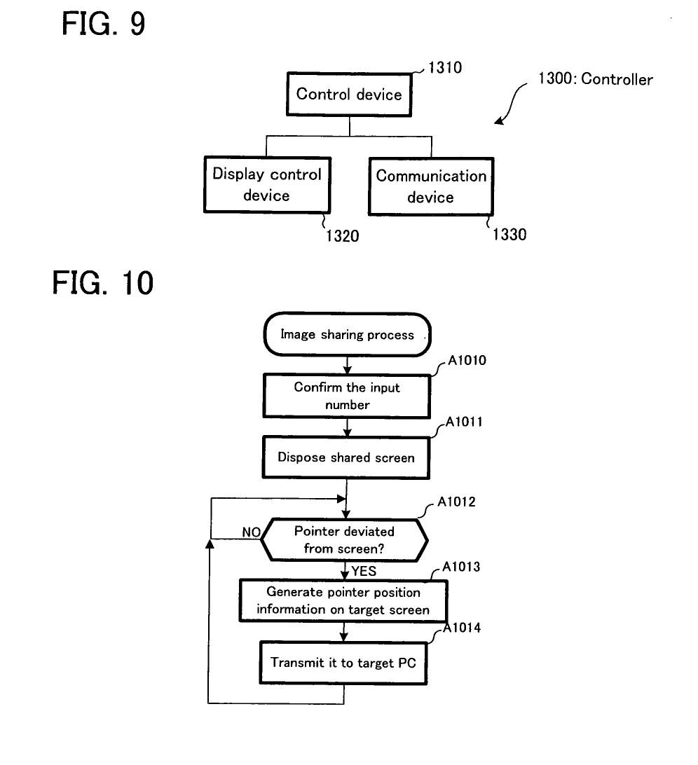

Next, with reference to FIG. 9, the detailed structure of the controller 1300 will be explained. FIG. 9 is a block diagram showing the controller 1300. Incidentally, in FIG. 9, the repeated points of FIG. 7 carry the same numerical references, and the explanation thereof will be omitted, as occasion demands.

In FIG. 9, the controller 1300 is provided with: a control device 1310; a display control device 1320; and a communication device 1330.

The control device 1310 is provided with a CPU (Central Processing Unit), a ROM (Read Only Memory), and a RAM (Random Access Memory) or the like. It is a controlling unit for controlling all the operations of the controller 1300, and it is constructed to function as one example of the “sub controlling device”, the “sub display data generating device”, the “arrangement aspect determining device”, the “actual position specifying device”, the “display position determining device”, and the “display position data generating device” of the present invention. Incidentally, the ROM of the control device 1310 stores therein an application program about the image sharing process, and the control device 1310 can perform the image sharing process by executing the application program.

The display control device 1320 is a display controlling unit for controlling the display apparatus 1301 so as to display a share screen or image plane X1 (i.e. one example of the “sub screen” of the present invention) on the screen device 1302 of the display apparatus 1301. It is constructed to function as one example of the “sub controlling device” of the present invention, together with the control device 1310.

The communication device 1330 is a communication interface for performing data communication between the PC 1100 and the PC 1200 through the network 1011. It is one example of the “sub communicating device” of the present invention.

<Operation of Embodiment>

<Display of Shared screen on Each PC>

On the PC 1100 and the PC 1200, the shared screens W1 and W2 are displayed on the display apparatuses 1101 and 1201, respectively. Hereinafter, a flow of the display of the shared screen will be explained. Incidentally, each PC has the same flow of this process, so that the process of the PC 1100 will be explained.

On the PC 1100, the control device 1110 provides superior control to the display control device 1150. For example, by supplying various display data, including the display data of the OS screen of the PC 1100 and the display data of a window about various application or the like, to the display control device 1150, the control device 1110 displays the shared screen W1 on the screen device 1102. Moreover, the operation amount of the cursor and the pointer (i.e. one example of the “instruction information” of the present invention) for representing the operation position of the input device 1120 is detected as an electrical signal by the position detection device 1130, and it is converted to position data by the control device 1110. By supplying the position data to the display control device 1150, the control device 1110 displays the pointer and the cursor in the display position corresponding to the operation amount of the input device 1120. In this manner, the shared screen is displayed on the screen device of each display apparatus, under each PC environment.

<Details of Image Sharing Process>

In the image display system 1010, by that the controller 1300 performs the image sharing process, it is possible to dispose the shared screens of both the PCs in the share screen X1 and to display them in a single screen. Now, with reference to FIG. 10, the details of the image sharing process will be explained. FIG. 10 is a flowchart showing the image sharing process.

Incidentally, as the previous stage of the image sharing process, the control device of each PC uses the authentication information stored in the USB memory and performs the authentication process with the controller 1300 (or the display apparatus 1301). If the authentication is not succeeded, the controller 1300 prohibits the shared screen of the PC from being disposed on the share screen X1. Incidentally, since the authentication process is known, the illustration thereof is omitted in order to prevent the complication of the drawing.

In FIG. 10, the control device 1310 firstly confirms the input number (step A1010). The input number in the fourth embodiment is the total number of screens to be disposed on the share screen X1, and in the fourth embodiment, the shared screens W1 and W2 correspond to the screens to be disposed, so that the input number is “2”. However, the controller 1300 and each PC are connected through the network 1011, which is a LAN network. Thus, the input number substantially does not have an upper limit, and many PCs can be connected. Along with that, according to the image sharing process in the fourth embodiment, it is also possible and easy to dispose more screens on the share screen X1.

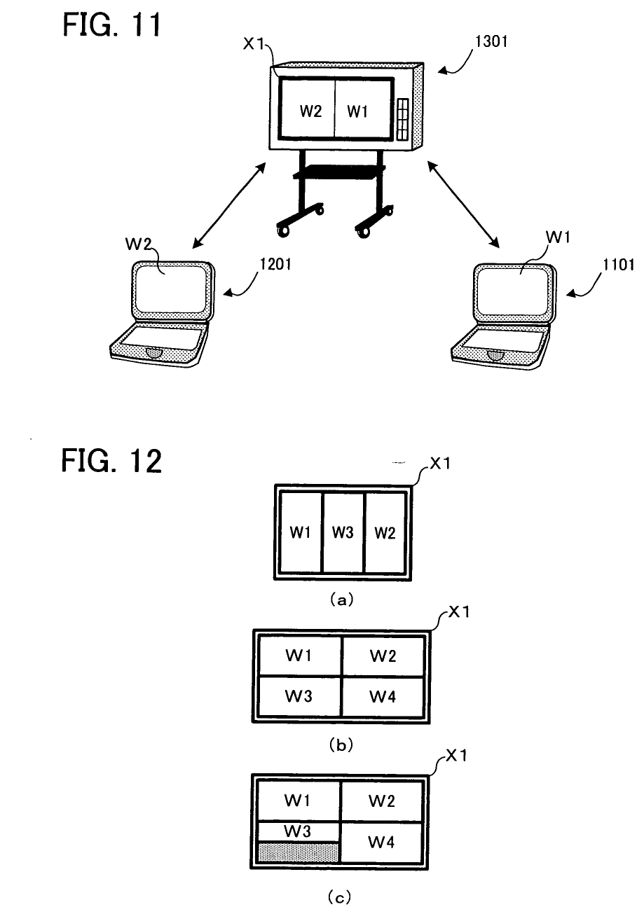

After confirming the input number, the control device 1310 disposes each shared screen on the share screen X1 (step A1011). Now, with reference to FIG. 11, an explanation will be given for the details of the share screen X1 on which the shared screens are disposed. FIG. 11 is a schematic diagram showing the image display of the image display system. Incidentally, in FIG. 11, the repeated points of FIG. 7 carry the same numerical references, and the explanation thereof will be omitted, as occasion demands.

In FIG. 11, the share screen X1 is displayed on the display apparatus 1301. On the share screen X1, the shared screens W1 and W2 are disposed in a uniform size, and as shown in FIG. 11, the shared screen W2 corresponding to the PC 1200 is disposed on the left, and the shared screen W1 corresponding to the PC 1100 is disposed on the right.

Incidentally, there is no limitation on the arrangement aspect of the shared screens on the share screen X1. Now, with reference to FIG. 12, the arrangement of the shared screens will be explained. FIG. 12 are schematic diagrams showing variations of arrangement of the shared screens on the share screen X1. Incidentally, in FIG. 12, the repeated points of FIG. 11 carry the same numerical references, and the explanation thereof will be omitted, as occasion demands.

In FIG. 12, if the input number is “3”, the shared screens W1, W2, and W3 may be displayed in parallel in the screen transverse direction on the share screen X1 (refer to FIG. 12(a)). Moreover, if the input number is “4”, the shared screens W1, W2, W3, and W4 may be displayed uniformly on the left, right, top, and bottom on the share screen X1 (refer to FIG. 12(b)). Alternatively, if the resolution of the corresponding display apparatus in one portion of the PCs included in the image display system 1010, for example, is different from that of the display apparatus 1031 or in similar cases, the shared screens are not necessarily disposed uniformly in the shared screen X1 (refer to FIG. 12(c)).

Incidentally, except for the aspects shown in FIG. 12, the arrangement aspect of the shared screens on the share screen X1, which is one example of the “sub screen” of the present invention, may be determined individually and specifically. For example, the individual shared screens may be not necessarily disposed uniformly. Alternatively, all the inputted shared screens (e.g. the screen W1 and the screen W2) are not necessarily included in the share screen X1. Such an arrangement aspect of each shared screen on the share screen X1 may be determined by the control device 1310 of the controller 1300, as occasion demands.

Back in FIG. 10, if the shared screens W1 and W2 are disposed on the share screen X1, the control device 1310 judges whether or not the pointer (or cursor, etc.) is displaced to the outside of the shared screen W1 or W2 (step A1012).

On each PC, it is judged whether or not the pointer is displaced to the outside of the screen, on the basis of the display position of the pointer and the operation amount of the input device 1120 (or 1220) detected by the position detection device 1130 (or 1230). If the pointer is displaced to the outside of the screen, the control device 1110 (or 1210) calculates the virtual display position of the pointer, which is outside the shared screen, on the basis of the detected operation amount or the like, and transmits the data representing the virtual display position to the controller 1300. The controller 1300 judges that the pointer is displaced to the outside of the screen when obtaining the data representing the virtual display position (the step A1012: YES). Incidentally, if the pointer is operated and displaced in each shared screen (the step A1012: NO), the controller 1300 repeats the process of the step A1012, and controls the process in a waiting condition. Incidentally, even in this case, the display of the share screen X1 is always controlled, on the basis of the display data about the shared screen.

If there is the shared screen of which the pointer is displaced to the outside (i.e. if an input to displace the instruction image to the outside of the screen is given), the control device 1310 specifies a shared screen (hereinafter referred to as a “target screen”, as occasion demands) which is a destination of the displacement of the pointer from the above shared screen of which the pointer is displaced to the outside and generates the position information about the pointer on the target screen (step A1013).

After generating the position information about the pointer on the target screen, the control device 1310 transmits the data representing the position information, to the PC corresponding to the target screen (step A1014). Along with that, on the PC corresponding to the target screen, the display control device is controlled so as to display the pointer in the position corresponding to the position information. Eventually, on the PC corresponding to the target screen, the pointer position is forcedly displaced in response to the input from the other PC. Along with this, the display content of the share screen X1 is also changed inevitably. If the process of the step A1014 is ended, the process is returned to the step A1012, and the display of the share screen X1 is continued.

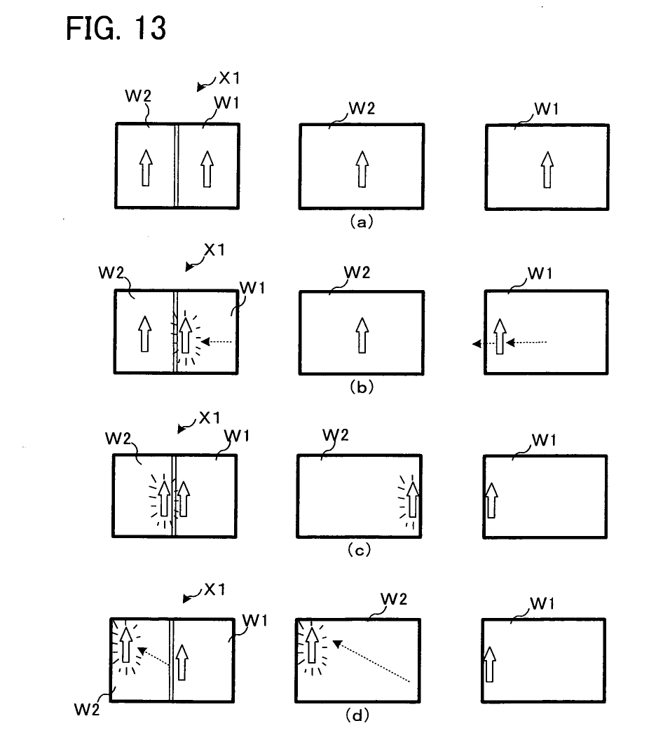

Now, with reference to FIG. 13, an explanation will be given for the transfer of the operation right of the pointer as described above. Here, FIG. 13 are schematic diagrams showing the transfer of the operation right of the pointer. Incidentally, in FIG. 13, the repeated points of FIG. 12 carry the same numerical references, and the explanation thereof will be omitted, as occasion demands.

In FIG. 13, the pointers are displaced near the centers of the shared screens W1 and W2. Along with that, in the share screen X1, these shared screens are disposed in parallel, and the pointers are displayed near the centers of the respective shared screens (refer to FIG. 13(a)).

Next, on the shared screen W1, it is assumed that the pointer is operated and displaced toward the left direction, and an input indicating to displace the pointer to the outside of the screen is given. In this case, even on the share screen X1, the pointer is displaced to the left in the area of the shared screen W1 located on the right side (refer to FIG. 13(b)).

Here, the shared screen W2 is disposed on the left of the shared screen W1, and if an instruction to displace the pointer to the outside of the screen by the displacement of the pointer in the illustrated direction is given, the target screen is the shared screen W2. Thus, the operation right of the pointer on the shared screen W2 is transferred from the PC 1200 (or a user who uses the PC 1200) to the PC 1100 (or a user who uses the PC 1100) (refer to FIG. 13(c)).

At the same time, the display position of the pointer in the shared screen W2 is determined on the basis of the displacement operation amount of the pointer on the shared screen W1. Eventually, by the pointer operation which is performed by the PC 1100 to which the operation right is transferred and which is performed on the shared screen W1, the pointer on the shared screen W2, which is originally under the control of the PC 1200, is so-to-speak forcedly displaced (refer to FIG. 13(d)).

As described above, according to the image display system 1010 in the fourth embodiment, the plurality of PCs, which desire to mutually share the screen, are connected to the controller 1300 through the network 1011, so that there is no substantial limitation on the number of sharable screens. Moreover, the input from each of the plurality of PCs, which desire to mutually share the screen, always goes through the controller 1300, so that it is also possible and easy to always optimize the various display aspects, such as arrangement, of the shared screens on the share screen X1. Moreover, the display content of the share screen X1 is controlled through the controller 1300, as described above. Thus, by that the input indicating to displace the pointer to the outside of the screen is given from each PC, it is also possible to share the operation right of the pointer between the mutual shared screens, which are adjacent to each other on the share screen X1. Namely, according to the image sharing system in the fourth embodiment, it is possible to display the plurality of screens on one screen, efficiently and effectively.

Incidentally, considering the practical use conditions of the image sharing system, there may be some situation that it is not desired to share the operation right of the instruction image, such as the pointer, with the other PC or PCs. In preparation for this case, it may be also constructed such that it is possible to set in advance whether or not the operation right of the pointer can be shared, on each PC side, as occasion demands.

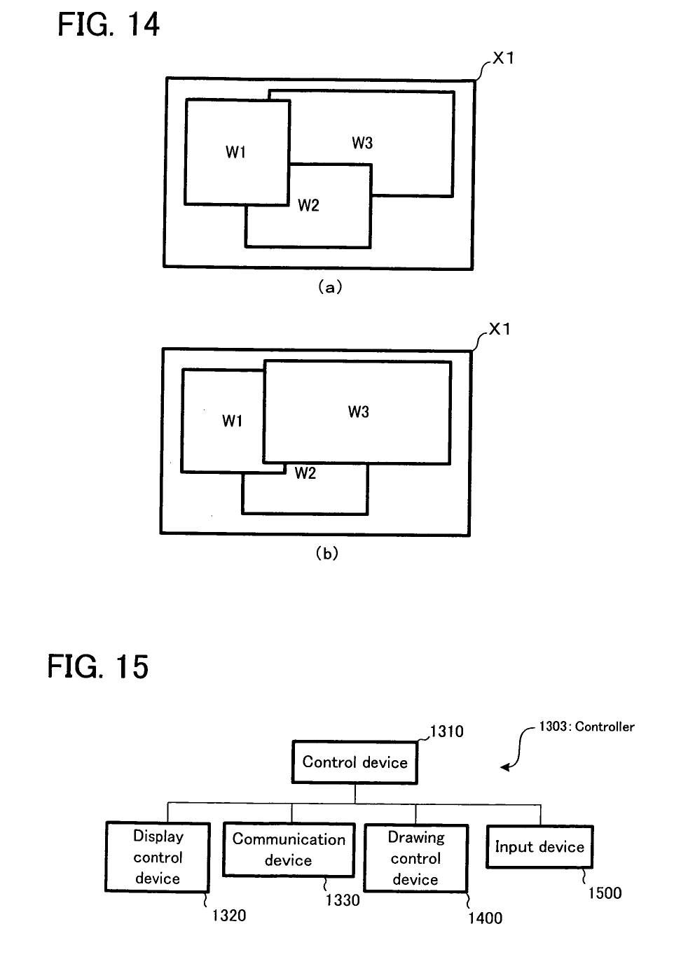

Now, with reference to FIG. 14, the display aspect of the shared screens on the share screen X1 will be complemented. FIG. 14 are schematic diagrams showing the display aspects of arrangement of the shared screens on the share screen X1. Incidentally, in FIG. 14, the repeated points of FIG. 12 carry the same numerical references, and the explanation thereof will be omitted, as occasion demands.

In FIG. 14, the three types of shared screens W1, W2, and W3 are disposed on the share screen X1. The shared screens are all displayed as windows, which are scalable and which can be operated and displaced, or the like. The shared screens can be easily overlapped. For example, it is possible to dispose the shared screens W1, W2, and W3 in this order from the front to the rear side (refer to FIG. 14(a)).

Incidentally, as described above, if the operation right is transferred or in similar cases, the window corresponding to the shared screen that is an operation target at the current time point may be quickly displayed in front. For example, if the pointer is displaced from the shared screen W1 to the shared screen W3, the shared screen W3 may be displayed in front (refer to FIG. 14(b)). Moreover, the initial display position of the pointer when the pointer is displaced among the windows overlapping each other as described above, may be determined to be continuous among the shared screens, or may be determined to be discontinuous by displaying the pointer on the edge portion of the window to which the pointer is displaced.

### Fifth Embodiment

Next, the fifth embodiment of the present invention will be explained, in which the fourth embodiment is further developed. Firstly, with reference to FIG. 15, the structure of an image display system in the fifth embodiment of the present invention will be explained. FIG. 15 is a block diagram showing a controller 1303 in the fifth embodiment of the present invention. Incidentally, in FIG. 15, the repeated points of FIG. 9 carry the same numerical references, and the explanation thereof will be omitted, as occasion demands.

In FIG. 15, the controller 1303 has the structure of the controller 1300 in the fourth embodiment, and is further provided with a drawing control device 1400 and an input device 1500.

The drawing control device 1400 is a drawing processing unit for drawing an arbitrary image on the share screen X1. The drawing control device 1400 is provided with a not-illustrated drawing panel, and the drawing panel is disposed to overlap the screen device 1302 of the display apparatus 1301. The drawing panel is constructed such that an erasable image is arbitrarily drawn in the corresponding portion by applying physical pressure (i.e. pressure from a pen operation and a touch operation or the like).

The input device 1500 is an input unit constructed to draw the image on the screen device 1302 in conjunction with the drawing control device 1400.

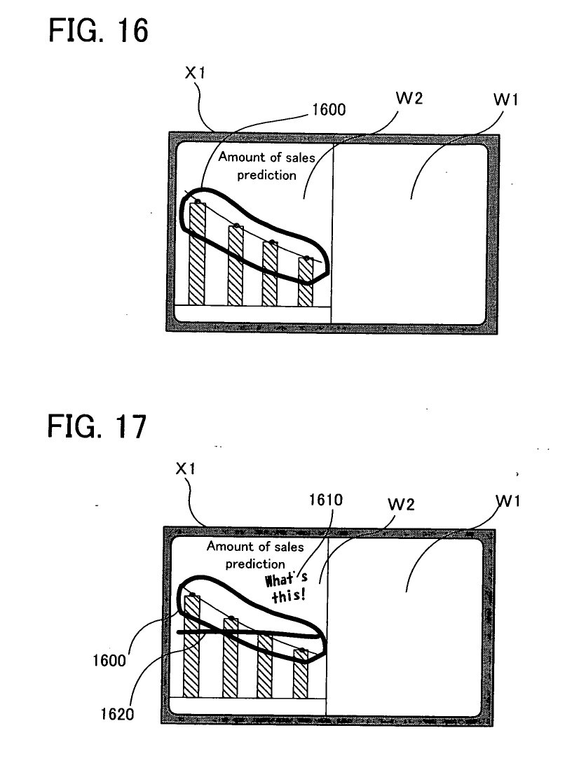

Next, with reference to FIG. 16, the operation of the fifth embodiment will be explained. FIG. 16 is a schematic diagram showing the share screen X1. Incidentally, in FIG. 16, the repeated points of FIG. 12 carry the same numerical references, and the explanation thereof will be omitted, as occasion demands.

In FIG. 16, an inserted image 1600 is drawn in an area corresponding to the shared screen W2. The inserted image 1600 is an image drawn by the drawing control device 1400 in response to the input operation from the input device 1500.

As described above, according to the controller 1303 in the fifth embodiment, by providing the input device 1500 and the drawing control device 1400, it is possible to freely draw the image on the share screen X1 shown in the fourth embodiment. Therefore, if the image display system is used for a conference or the like, various effects can be expected, such as smooth communication and enhancement of a certain portion on the screen.

<Modified Example>

As a modified example of the fifth embodiment, the following can be considered. Now, with reference to FIG. 17, the modified example of the fifth embodiment will be explained. FIG. 17 is another schematic diagram showing the share screen X1. Incidentally, in FIG. 17, the repeated points of FIG. 16 carry the same numerical references, and the explanation thereof will be omitted, as occasion demands.

In FIG. 17, in addition to the above-mentioned inserted image 1600, inserted images 1610 and 1620 are further drawn on the share screen X1. The inserted images 1610 and 1620 are images inputted through the input devices 1120 and 1220 from the PCs 1100 and 1200, respectively.

Namely, the control device 1310 obtains the position in which the input operation from each PC is performed, and transmits a request to make a drawing, to the drawing control device 1400, simultaneously with the input from the input device 1500. Along with this, the inserted image inputted from each PC is drawn on the share screen X1 by the drawing control device 1400. Thus, it is more effective. Incidentally, in order to identify each PC, the display color of the inserted image may be changed for each PC. In this case, visibility is improved, so that it is further effective.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2005-352030 filed on Dec. 6, 2005 and Japanese Patent Application No. 2005-352098 filed on Dec. 6, 2005 including the specification, claims, drawings and summary is incorporated herein by reference in its entirety.

What is claimed is:

1. An image display control apparatus for controlling a main display apparatus which has a main display screen for displaying an image and a sub display apparatus which has a sub display screen for displaying the image, said image display control apparatus comprising:
a storing device for storing predetermined types of setting information necessary to display the image on the sub display screen, said storing device being constructed to be detachable to said image display control apparatus;
a display position determining device for determining a display position of at least one portion of the image to be displaced, on the sub display screen or the main display screen, on the basis of the setting information, if an input indicating to displace the at least one portion of the image displayed on the main display screen or the sub display screen to an outside of a screen of the main or sub display screen is given, in such a condition that said storing device is attached; and
a controlling device for controlling said sub display apparatus or said main display apparatus to display the at least one portion of the image to be displaced, in the determined display position.

2. The image display control apparatus according to claim 1, wherein
the setting information includes authentication information for authenticating said sub display apparatus,
said image display control apparatus further comprises an authenticating device for performing a predetermined authentication process with said sub display apparatus, on the basis of the authentication information, in such a condition that said storing device is attached, and
said display position determining device determines the display position on the sub display screen, which is provided for said sub display apparatus which is authenticated as a result of the authentication process.

3. The image display control apparatus according to claim 1, wherein said display position determining device determines the display position such that a displacement direction of the image on the main display screen corresponds to a displacement direction of the image on the sub display screen.

4. The image display control apparatus according to claim 1, wherein said display position determining device determines the display position on the sub display screen or the main display screen, in a vertically reversed position or a horizontally reversed position with respect to the display position on the main display screen or the sub display screen, in accordance with a displacement direction of the image, if the input indicating to displace the image is given.

5. The image display control apparatus according to claim 1, further comprising a selecting device for selecting two display screens, if there are the plurality of sub display apparatuses, which are displacement targets of the image, from among the main display screen and a plurality of sub display screens provided for the plurality of sub display apparatuses,
said display position determining device determining the display position of at least one portion of the image to be displaced, between the selected display screens, if the input indicating to displace the image is given.

6. The image display control apparatus according to claim 5, wherein said selecting device selects the two display screens in accordance with an input indicating to specify the two display screens which are the displacement targets.

7. An image display control apparatus for controlling a main display apparatus which has a main display screen for displaying an image and a sub display apparatus which has a sub display screen for displaying the image, said image display control apparatus comprising:
a storing device for storing predetermined types of setting information necessary to display the image on the sub display screen, said storing device being constructed to be detachable to said image display control apparatus, the setting information including position relationship information which represents a virtual position relationship between the main display screen and the sub display screen;
a judging device for judging whether or not there is the sub display screen or the main display screen in a direction toward which displacement is promoted by an input indicating to displace at least one portion of the image, on the basis of the position relationship information, if the input indicating to displace the at least one portion of the image displayed on the main display screen or the sub display screen to an outside of a screen of the main or sub display screen is given, in such a condition that said storing device is attached; and
a display position determining device for determining a display position of the at least one portion of the image to be displaced, on the sub display screen or the main display screen, on the basis of the setting information, if it is judged that there is the sub display screen or the main display screen; and
a controlling device for controlling said sub display apparatus or the main display apparatus to display the at least one portion of the image to be displaced, in the determined display position.

8. An image display system included in a network, comprising: a control terminal; and a controlled terminal, said control terminal controlling a main display apparatus having a main display screen for displaying an image,
said controlled terminal comprising:
a sub display apparatus having a sub display screen for displaying the image,
said control terminal further comprising:
a storing device for storing predetermined types of setting information necessary to display the image on the sub display screen, said storing device being constructed to be detachable to an image display control apparatus;
a display position determining device for determining a display position of at least one portion of the image to be displaced, on the sub display screen or the main display screen, on the basis of the setting information, if an input indicating to displace the at least one portion of the image displayed on the main display screen or the sub display screen to an outside of a screen of the main display screen or sub display screen is given, in such a condition that said storing device is attached;
a control-terminal-side controlling device for controlling said main display apparatus to display the at least one portion of the image to be displaced, in the determined display position, if there is the determined display position on the main display screen;
a generating device for generating control information for displaying the at least one portion of the image to be displaced, in the determined display position, if there is the determined display position on the sub display screen; and
a control-terminal-side communicating device for transmitting the control information to said controlled terminal through the network,
said controlled terminal further comprising.
a controlled-terminal-side controlling device for controlling said sub display apparatus to display the at least one portion of the image to be displaced, in the determined display position, on the basis of the transmitted control information.

9. An image display control method of controlling a main display apparatus and a sub display apparatus which have a main display screen and a sub display screen for displaying an image, respectively, said image display control method comprising:
a display position determining process of determining a display position of at least one portion of the image to be displaced, on the sub display screen or the main display screen, on the basis of setting information, if an input indicating to displace the at least one portion of the image displayed on the main display screen or the sub display screen to an outside of a screen of the main display screen or the sub display screen is given, in such a condition that a storing device is attached, said storing device storing predetermined types of the setting information necessary to display the image on the sub display screen, said storing device being constructed to be detachable to an image display control apparatus; and
a controlling process of controlling said sub or main display apparatus to display the at least one portion to be displaced, in the determined display position.

10. A computer program product in a computer-readable medium for tangibly embodying a program of instructions executable by a computer provided in an image display control apparatus, to make the computer function as a display position determining device and a controlling device,
said image display control apparatus for controlling a main display apparatus which has a main display screen for displaying an image and a sub display apparatus which has a sub display screen for displaying the image, said image display control apparatus comprising:
a storing device for storing predetermined types of setting information necessary to display the image on the sub display screen, said storing device being constructed to be detachable to said image display control apparatus;
said display position determining device for determining a display position of at least one portion of the image to be displaced, on the sub display screen or the main display screen, on the basis of the setting information, if an input indicating to displace the at least one portion of the image displayed on the main display screen or the sub display screen to an outside of a screen of the main or sub display screen is given, in such a condition that said storing device is attached; and
said controlling device for controlling said sub display apparatus or said main display apparatus to display the at least one portion of the image to be displaced, in the determined display position.

11. A computer program product in a computer-readable medium for tangibly embodying a program of instructions executable by a computer provided in an image display control apparatus, to make the computer function as a display position determining device and a controlling device,
said image display control apparatus for controlling a main display apparatus which has a main display screen for displaying an image and a sub display apparatus which has a sub display screen for displaying the image, said image display control apparatus comprising:
a storing device for storing predetermined types of setting information necessary to display the image on the sub display screen, said storing device being constructed to be detachable to said image display control apparatus, the setting information including position relationship information which represents a virtual position relationship between the main display screen and the sub display screen;
a judging device for judging whether or not there is the sub display screen or the main display screen in a direction toward which displacement is promoted by an input indicating to displace at least one portion of the image, on the basis of the position relationship information, if the input indicating to displace the at least one portion of the image displayed on the main display screen or the sub display screen to an outside of a screen of the main or sub display screen is given, in such a condition that said storing device is attached; and
said display position determining device for determining a display position of the at least one portion of the image to be displaced, on the sub display screen or the main display screen, on the basis of the setting information, if it is judged that there is the sub display screen or the main display screen; and
said controlling device for controlling said sub display apparatus or the main display apparatus to display the at least one portion of the image to be displaced, in the determined display position.

12. An image display system included in a network, comprising: a plurality of main display control apparatuses for controlling respective main display apparatuses; and a sub display control apparatus for controlling a sub display apparatus,
each of said plurality of main display control apparatuses comprising:
a main controlling device for controlling said main display apparatus to display a main screen,
a main display data generating device for generating main display data for displaying the main screen on said sub display apparatus; and
a main communicating device for transmitting the main display data to said sub display control apparatus through the network,
said sub display control apparatus comprising:
a sub display data generating device for generating sub display data for displaying a predetermined type of sub screen, including at least one portion of a plurality of main screens, each of which corresponds to said plurality of main display control apparatuses respectively, on the basis of the transmitted main display data; and
a sub controlling device for controlling said sub display apparatus to display the sub screen in accordance with the sub display data.

13. The image display system according to claim 12, wherein said sub display control apparatus further comprises an arrangement aspect determining device for determining an arrangement aspect of the at least one portion of the plurality of main screens included in the sub screen, on the basis of at least one of (i) number of the at least one portion of the plurality of main screens included in the sub screen and (ii) priority of the at least one portion of the plurality of main screens included in the sub screen.

14. The image display system according to claim 12, wherein
each of said plurality of main display control apparatuses further comprises:
a storing device for storing authentication information for authenticating said sub display apparatus, said storing device being constructed to be detachable to each of said plurality of main display control apparatus; and
an authenticating device for performing an authentication process between each of said plurality of main display control apparatuses and said sub display apparatus, on the basis of the authentication information, in such a condition that said storing device is attached, and
said sub display data generating device generates the sub display data, on the basis of the main display data transmitted from said main display control apparatus which is authenticated as a result of the authentication process.

15. The image display system according to claim 12, wherein
the main screen includes an instruction image for instructing a position on the main screen,
each of said plurality of main display control apparatuses further comprises:
a virtual position specifying device for specifying a virtual position of the instruction image on an outside of the main screen, if an input indicating to displace the instruction image to the outside of the main screen is given; and
a virtual position data generating device for generating virtual position data corresponding to the virtual position,
said main communicating device transmits the virtual position data to said sub display control apparatus through the network,
said sub display control apparatus further comprises:
an actual position specifying device for specifying an actual position of the instruction image on the sub screen, represented by the transmitted virtual position data;
a display position determining device for determining a display position of the instruction image on the main screen to which the actual position belongs, from among the at least one portion of the plurality of main screens included in the sub screen, on the basis of the actual position;
a display position data generating device for generating display position data which represents the determined display position; and
a sub communicating device for transmitting the display position data to said main display control apparatus corresponding to the main screen to which the actual position belongs, through the network, and
said main controlling device of said main display control apparatus corresponding to the main screen to which the actual position belongs, controls arrangement of the instruction image on the main screen, on the basis of the transmitted display data.

16. The image display system according to claim 12, wherein said sub display control apparatus further comprises a drawing device for drawing an image, which is different from that of the main screen, on the sub screen, in accordance with a predetermined input.

17. A sub display control apparatus for an image display system, included in a network and provided for an image display system including a plurality of main display control apparatuses, each of said plurality of main display control apparatuses (i) controlling a plurality of main display apparatuses and (ii) comprising: a main controlling device for controlling the plurality of main display apparatuses to display a main screen; a main display data generating device for generating main display data for displaying the main screen; and a main communicating device for transmitting the main display data through the network, said sub display control apparatus for an image display system comprising:
a sub display data generating device for generating sub display data for displaying a predetermined types of sub screen including at least one portion of a plurality of main screens, each of which corresponds to said plurality of main display control apparatuses respectively, on the basis of the transmitted main display data; and
a sub controlling device for controlling said sub display apparatus to display the sub screen in accordance with the sub display data.

18. An image display method in an image display system included in a network, comprising: a plurality of main display control apparatuses for controlling respective main display apparatuses; and a sub display control apparatus for controlling a sub display apparatus,
in each of said plurality of main display control apparatuses, said method comprising:
a main controlling process of controlling said main display apparatus to display a main screen,
a main display data generating process of generating main display data for displaying the main screen on said sub display apparatus; and
a main communicating process of transmitting the main display data to said sub display control apparatus through the network,
in said sub display control apparatus, said method comprising:
a sub display data generating process of generating sub display data for displaying a predetermined types of sub screen, including at least one portion of a plurality of main screens, each of which corresponds to said plurality of main display control apparatuses respectively, on the basis of the transmitted main display data; and
a sub controlling process of controlling said sub display apparatus to display the sub screen in accordance with the sub display data.

19. A computer program product in a computer-readable medium for tangibly embodying a program of instructions executable by a computer provided in an image display system, to make the computer function as one of a plurality of main display control apparatuses,
said image display system comprising: said plurality of main display control apparatuses for controlling respective main display apparatuses; and a sub display control apparatus for controlling a sub display apparatus, said plurality of main display control apparatuses and said sub display control apparatus being included in a network,
each of said plurality of main display control apparatuses comprising:
a main controlling device for controlling said main display apparatus to display a main screen,
a main display data generating device for generating main display data for displaying the main screen on said sub display apparatus; and
a main communicating device for transmitting the main display data to said sub display control apparatus through the network,
said sub display control apparatus comprising:
a sub display data generating device for generating sub display data for displaying a predetermined type of sub screen, including at least one portion of a plurality of main screens, each of which corresponds to said plurality of main display control apparatuses respectively, on the basis of the transmitted main display data; and
a sub controlling device for controlling said sub display apparatus to display the sub screen in accordance with the sub display data.

20. A computer program product in a computer-readable medium for tangibly embodying a program of instructions executable by a computer provided in an image display system, to make the computer function as a sub display control apparatus,
said image display system comprising: a plurality of main display control apparatuses for controlling respective main display apparatuses; and the sub display control apparatus for controlling a sub display apparatus, said plurality of main display control apparatuses and said sub display control apparatus being included in a network,
each of said plurality of main display control apparatuses comprising:
a main controlling device for controlling said main display apparatus to display a main screen,
a main display data generating device for generating main display data for displaying the main screen on said sub display apparatus; and
a main communicating device for transmitting the main display data to said sub display control apparatus through the network,
said sub display control apparatus comprising:
a sub display data generating device for generating sub display data for displaying a predetermined type of sub screen, including at least one portion of a plurality of main screens, each of which corresponds to said plurality of main display control apparatuses respectively, on the basis of the transmitted main display data; and
a sub controlling device for controlling said sub display apparatus to display the sub screen in accordance with the sub display data.
